(19) United States
(12) Patent Application Publication
(10) Pub. No.: US 2025/0053278 A1
(43) Pub. Date: Feb. 13, 2025

(54) INFORMATION PROCESSING METHOD AND APPARATUS, STORAGE MEDIUM, AND ELECTRONIC DEVICE

(71) Applicant: Beijing Zitiao Network Technology Co., Ltd., Beijing (CN)

(72) Inventors: Yuzhen CAI, Beijing (CN); Hongfeng LIN, Beijing (CN)

(21) Appl. No.: 18/720,512

(22) PCT Filed: Dec. 13, 2022
(86) PCT No.: PCT/CN2022/138557

§ 371 Date: Jun. 14, 2024

(30) Foreign Application Priority Data
Dec. 14, 2021 (CN) 202111531581.8

(51) Int. Cl. G06F 3/0483; G06F 3/04817; G06F 3/04845

(52) U.S. Cl. CPC G06F 3/0483; G06F 3/04817; G06F 3/04845

(57) ABSTRACT

An information processing method and apparatus, a storage medium, and an electronic device. The method includes: displaying a page of a first document; displaying a switching identifier in response to a triggering operation on target content in the page of the first document, the target content being displayed in a first form; displaying the target content in a second form in the page of the first document in response to a triggering operation on the switching identifier, the first form including one of a text form or a page form and the second form including the other one of the text form or the page form.

### CROSS-REFERENCE TO RELATED APPLICATIONS

The present disclosure is a U.S. National Stage Application under 35 U.S.C. § 371 of International Patent Application No. PCT/CN2022/138557, filed on Dec. 13, 2022, which is based on and claims priority of Chinese application for invention No. 202111531581.8, filed on Dec. 14, 2021, the disclosures of which are incorporated herein by reference in their entireties.

### TECHNICAL FIELD

The present disclosure relates to the field of computer technology, in particular to an information processing method, an information processing apparatus, a non-transitory computer-readable storage medium and an electronic device implementing an information processing method.

### BACKGROUND

During a document editing process, text may be entered to record content. In addition to entering text to record information, user also has higher demand on text presentation style, and prefer a variety of display styles.

In related arts, text attributes such as color, font, font size, and background color may be set to enrich display styles.

### SUMMARY

Some embodiments of the present disclosure provide an information processing method, an information processing apparatus, a computer-readable storage medium and an electronic device implementing an information processing method.

In a first aspect, some embodiments of the present disclosure provide an information processing method, comprising: displaying a page of a first document;
displaying a switch identifier, in response to a trigger
operation on a target content on the page of the first document, wherein the target content is displayed in a first form; and
displaying the target content in a second form on the page of the first document, in response to a trigger operation on the switch identifier, wherein the first form comprises one of a text form and a page form, and the second form comprises another of the text form and the page form.

In some embodiments, the page form comprises at least one of an icon, a background image, a title, or designated content information comprising content information corresponding to the target content.

In some embodiments, the target content comprises a target link, and the switch identifier comprises a first switch identifier, the method comprising: in response to a trigger operation on the target link on
the page of the first document, displaying the first switch identifier;
in response to a trigger operation on the first switch identifier, displaying a preset page on the page of the first document, the preset page comprising content information corresponding to the target link.

In some embodiments, the method further comprises:
in response to an input operation on the target link received on the page of the first document, displaying the first switch identifier;
in response to a trigger operation on the first switch identifier, displaying a preset page on the page of the first document, the preset page comprising content information corresponding to the target link.

In some embodiments, the first switch identifier comprises a first identifier and at least one second identifier, wherein the first identifier is used to display and switch to a first form of the target link, and the second identifier is used to display and switch to a second form of the target link.

In some embodiments, the target content comprises a content block, and the switch identifier comprises a second switch identifier, the method comprising:
in response to a trigger operation on the content block on the page of the first document, displaying the second switch identifier;
in response to a trigger operation on the second switch identifier, displaying a preset page on the page of the first document, the preset page comprising content information corresponding to the content block.

In some embodiments, the target content comprises a plurality of content blocks, and the switch identifier comprises a second switch identifier, the method comprising:
in response to a trigger operation on the plurality of content blocks on the page of the first document, displaying the second switch identifier;
in response to a trigger operation on the second switch identifier, displaying a preset page on the page of the first document, the preset page comprising content information corresponding to the plurality of content blocks.

In some embodiments, the method comprises:
displaying a preset control in response to a trigger operation on the second switch identifier;
in response to a trigger operation on the preset control, generating a second document that comprises the content block on the page of the first document.

In some embodiments, the method further comprises:
displaying a setting interface in response to an operation on a preset region in the page form;
in response to a selection operation on layout information in the setting interface, adjusting the display position and/or the display style of the page content in the page form.

In some embodiments, the selection operation on layout information in the setting interface comprises:
moving layout information along a preset direction in a preset region of the setting interface; in response to moving the layout information to a preset position, determining a selection operation on the layout information.

In some embodiments, the selection operation on layout information in the setting interface comprises: performing a move operation on layout information along a preset direction in a preset region of the setting interface; in response to moving the layout information to a preset position, determining the move operation as a selection operation on the layout information.

In some embodiments, in response to the page form comprising a title and designated content information, the method further comprises:
displaying a setting interface in response to an operation on a preset region in the page form;
in response to an input operation on the setting interface, modifying a background style for a region corresponding to the title and the designated content information in the page form.

In some embodiments, in response to an input operation on the setting interface, modifying a background style for a region corresponding to the title and the designated content information in the page form comprises:
obtaining target background style data in response to an input operation on the setting interface;
modifying the default background style data of the region corresponding to the title and the designated content information in the page form to the target background style data;
performing a rendering process based on the target background style data to change the background style of the region corresponding to the title and the designated content information in the page form.

In some embodiments, in response to the page form comprising a background image, the method further comprises:
displaying a setting interface in response to an operation on a preset region in the page form;
in response to a selection operation on a preset background image in the setting interface, displaying the background image in a preset region in the page form.

In some embodiments, the method further comprises:
in response to the background image being set to null and a background color being set to non-null, filling a background image region of the page with the background color.

In some embodiments, in response to the page form comprising an icon, the method further comprises:
displaying an emoji selection interface in response to a trigger operation on a preset icon control in the page form;
in response to a selection operation on any emoji in the emoji selection interface, displaying the emoji in an icon region in the page form.

In some embodiments, the target content comprises a content block, and the switch identifier comprises a second switch identifier, the method comprising:
in response to a trigger operation on the content block on the page of the first document, displaying the second switch identifier;
in response to a trigger operation on the second switch identifier, displaying a preset page on the page of the first document, the preset page comprising content information corresponding to the content block;
in response to a trigger operation on a preset icon control in the page form, when it is determined that there is an emoji in the content block on the page of the first document, displaying the emoji in the content block in the emoji selection interface as a recommended emoji.

In some embodiments, in response to a trigger operation on a preset icon control in the page form, if it is determined that there is an emoji in the content block on the page of the first document, the emoji in the content block is displayed in the emoji selection interface as a recommended emoji. In some embodiments, the method further comprises:
in response to a trigger operation on the second switch identifier, when it is determined that there is an emoji in the content block on the page of the first document, using the emoji as an emoji on the preset page displayed on the page of the first document.

In some embodiments, the information processing method further comprises: in response to a trigger operation on the second switch identifier, if it is determined that there is an emoji in the content block on the page of the first document, using the emoji as an emoji on the preset page displayed on the page of the first document.

In a second aspect, some embodiments of the present disclosure provide an information processing apparatus, comprising:
a first display module for displaying a page of a first document;
a second display module for displaying, in response to a trigger operation on a target content on the page of the first document, a switch identifier, wherein the target content is displayed in a first form;
a third display module for displaying, in response to a trigger operation on the switch identifier, the target content in a second form on the page of the first document, wherein the first form comprises one of a text form and a page form, and the second form comprises another of the text form and the page form.

In a third aspect, some embodiments of the present disclosure provide a non-transitory computer-readable storage medium having stored thereon a computer program that, when executed by a processor, implement the steps of the information processing method of any embodiment described above.

In a fourth aspect, some embodiments of the present disclosure provide an electronic device, comprising:
a processor; and
memory for storing a computer program,
wherein the processor is configured to perform the steps of the information processing method of any embodiment described above by executing the computer program.

In a fifth aspect, some embodiments of the present disclosure provide a computer program, comprising: instructions that, when executed by a processor, cause the processor to implement the steps of the information processing method of any embodiment described above.

### BRIEF DESCRIPTION OF THE DRAWINGS

Herein, the accompanying drawings, which are incorporated in and constitute a part of this specification, illustrate embodiments of the present disclosure and, together with the description, serve to explain the principles of the present disclosure.

In order to more clearly explain the embodiments of the present invention or the technical solutions in the prior art, a brief introduction will be given below for the drawings required to be used in the description of the embodiments or the prior art. It is obvious that, for a person skilled in the art, he or she may also acquire other drawings according to such drawings on the premise that no inventive effort is involved.

FIG. 1 is a flowchart of an information processing method provided by some embodiments of the present disclosure;

FIG. 2 is a flowchart of an information processing method provided by some other embodiments of the present disclosure;

FIG. 3 is a flowchart of an information processing method provided by some further embodiments of the present disclosure;

FIG. 4 is a schematic diagram of a document page provided by some embodiments of the present disclosure;

FIG. 5 is another schematic diagram of the document page provided by some embodiments of the present disclosure;

FIG. 6 is a flowchart of an information processing method provided by some further embodiments of the present disclosure;

FIG. 7 is a schematic diagram of a setting interface provided by some embodiments of the present disclosure;

FIG. 8 is a flowchart of an information processing method provided by some embodiments of the present disclosure;

FIG. 9 is a schematic diagram of an information processing apparatus provided by some embodiments of the present disclosure;

FIG. 10 is a schematic diagram of an electronic device for implementing the information processing method of some embodiments of the present disclosure.

### DETAILED DESCRIPTION

In order to better understand the above objects, features and advantages of the present disclosure, the scheme of the present disclosure will be further described below. It should be noted that, in the case of no conflict, the embodiments and the features of the embodiments of the present disclosure may be combined with each other.

Many specific details are set forth in the following description to facilitate a full understanding of the present disclosure, but the present disclosure can also be implemented in other ways different from those described herein. Obviously, embodiments described in the description are only some embodiments of the present disclosure, and are not all of embodiments thereof.

It should be understood that the term “at least one” used below in this description means “one or more”, and the term “a plurality of” means “two or more”. The term “and/or” as used herein is simply a description of the association of related objects, indicating that there may be three possible relationships of the related objects, for example, A and/or B can indicate the presence of A alone, the presence of both A and B, and the presence of B alone, where A and B may be in singular or plural. The character “/” in this description generally indicates that the objects associated before and after “/” have an “or” relationship. The phrase “at least one of the following items” or similar phrases refers to any combination of such items, comprising any combination of single or multiple items. For example, at least one of a, b, or c can represent: a, b, c, “a and b”, “a and c”, “b and c”, or “a and b and c”, where a, b, and c may be in singular or plural.

As mentioned above, the display style in related arts is limited to text only, and is too homogeneous to meet the editing needs of users.

In order to solve or at least partially solve the above technical problem, some embodiments of the present disclosure provide an information processing method, an information processing apparatus, a non-transitory computer-readable storage medium and an electronic device implementing the information processing method.

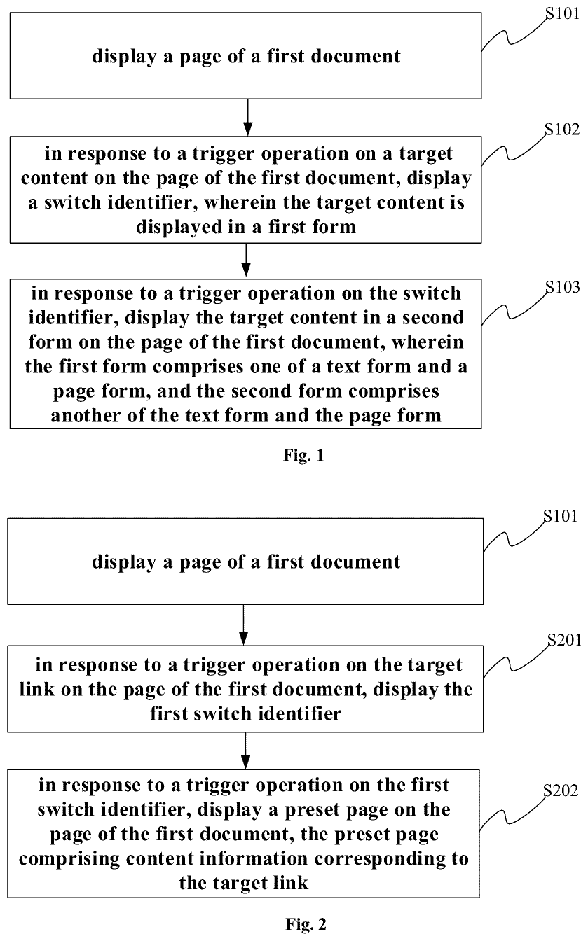

FIG. 1 is a flowchart of an information processing method provided by some embodiments of the present disclosure, which may be applied to electronic devices such as computers, mobile terminals, etc. The method may comprise the following steps. Step S101: display a page of a first document.

In some embodiments of the present embodiment, the page of the first document may be a document page, such as an editing page, displayed by a document editing application, or a document page of an online document such as a cloud document, which is not specifically limited in the embodiments. In one example, a user opens an online document on his computer and access a document page such as an editing page, which comprises at least an editing region.

Step S102: in response to a trigger operation on a target content on the page of the first document, display a switch identifier, wherein the target content is displayed in a first form.

In some embodiments disclosed herein, the target content may be a content that already exists in the document, or it may be a content that is being entered into the document. For example, the target content may be a link, a few texts, or a content block on the document page. A content block is a basic unit of a document. A document consists of one or more content blocks. A content block may be considered of as a short document, and each content block may contain multiple types of content. User may edit and input the content in a content block and perform content editing and management in content block units. A difference from a traditional online document is that a traditional document does not have the concept of content blocks, and the region of the document page may be considered as a same editing region. The trigger operation may be a mouse click or hover, and the switch identifier may be a control such as a virtual button, which is not limited in the embodiments. In some embodiments of the present disclosure, the first form may be a text form. In response to a user selecting or clicking on a link or a content block displayed in the text form on the document page, a corresponding virtual button is displayed.

In step S103: in response to a trigger operation on the switch identifier, display the target content in a second form on the page of the first document, wherein the first form comprises one of a text form and a page form, and the second form comprises another of the text form and the page form.

In some embodiments of the present disclosure, the first form is different from the second form. In response to a user clicking on the virtual button described above, for example, a link or a content block displayed in the text form is converted into a link or a content block displayed in the page form.

The above technical solution in the embodiments are capable to enrich the document display style, such as a text form and a page form that are not limited to a single text form, to meet the personalized editing needs of users.

In some embodiments, the page form may comprise at least one of an icon, a background image, a title, or designated content information comprising content information corresponding to the target content. In some embodiments of the present disclosure, in response to the target content being a link, the page form may comprise an icon corresponding to the link, a background image, and linked content corresponding to the link, such as a document title. The designated content information may be a linked content of the target link, such as some text in the document, but is not limited thereto. In this way, in response to adding a link to a document, for example, more information about the linked content may be displayed on the basis of an icon and a title, allowing an increased amount of information displayed and thereby increasing the probability that users click on the link to read the linked content.

The technical solution provided in the embodiments of the present disclosure has the following advantages over the related art.

The information processing method and apparatus, the storage medium, and the electronic device provided by some embodiments of the present disclosure are capable of displaying a page of a first document; in response to a trigger operation on a target content on the page of the first document, displaying a switch identifier, wherein the target content is displayed in a first form; in response to a trigger operation on the switch identifier, displaying the target content in a second form on the page of the first document; wherein the first form comprises one of a text form and a page form, and the second form comprises another of the text form and the page form. Thus, document display styles are not limited to a single text form, enrich the document display styles are enriched, such as a text form and a page form, to meet personalized editing needs of users.

In some embodiments, the target content may comprise a target link, and the switch identifier comprises a first switch identifier. As shown in FIG. 2, the method may further comprise the following steps.

Step S201: in response to a trigger operation on the target link on the page of the first document, display the first switch identifier.

Step S202: in response to a trigger operation on the first switch identifier, display a preset page on the page of the first document, the preset page comprising content information corresponding to the target link.

In some embodiments of the present application, the target link may be a link in the form of a Uniform Resource Locator (URL), and the object linked to may be a plain text document, a multimedia file such as a video file, and so on. The first switch identifier may be a control, such as a virtual button, that is configured to switch the presentation form of the target link in response to a trigger operation by a user, such as a click operation.

For example, in response to the document page comprising a target link in the text form, and in response to a trigger operation such as a click on the target link being detected, the display of the first switch identifier such as a virtual button (e.g., a button for Switching to a Card form) is triggered. in response to the user clicks on the displayed first switch identifier such as a virtual button, the target link is displayed in the page form in response to the click operation. The page form comprises an icon, a title, a background image, and designated content information. That is, the switched display form of the target link comprises not only an icon and a title, but also designated content information of linked content of the target link. Thereby, more information about the linked content may be displayed to increase the amount of information displayed, thereby increasing the probability that the user clicks on the link to read the linked content.

In some embodiments, the method further comprises: in response to receiving an input operation on the target link on the page of the first document, displaying the first switch identifier; in response to a trigger operation on the first switch identifier, displaying a preset page on the page of the first document, the preset page comprising content information corresponding to the target link.

In some embodiments of the present application, in response to a target link in the text form being entered on the editing region of a document page, the display of the first switch identifier such as a virtual button (e.g., a button for Switching to a Card form) is triggered. The user clicks on the displayed first switch identifier such as a virtual button, in response to the click operation, the target link is displayed in the page form. That is, a preset page is displayed on the document page, which comprises content information corresponding to the target link, such as some content information of a document linked to.

In some embodiments, the first switch identifier comprises a first identifier such as a first virtual button and at least one second identifier such as a second virtual button, wherein the first identifier is configured to display and switch to a first form (such as, text form) of the target link, and the second identifier is configured to display and switch to a second form (such as, page form) of the target link.

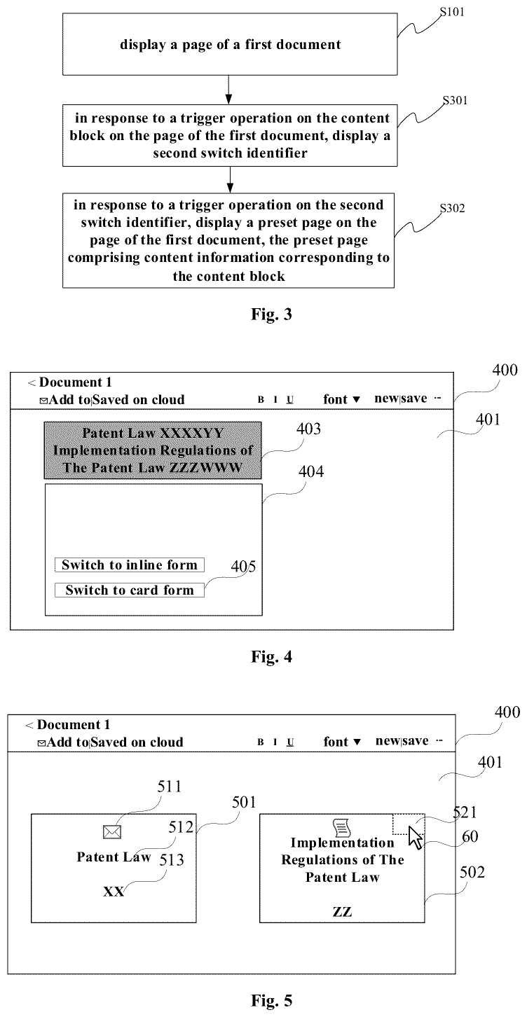

In some embodiments, the target content comprises a content block, and the switch identifier comprises a second switch identifier. The content block may be, but is not limited to, some content lines in a document page, such as a paragraph of an article. Accordingly, as shown in FIG. 3, the method may comprise the following steps.

Step S301: in response to a trigger operation on the content block on the page of the first document, display a second switch identifier.

In some embodiments of the present application, the trigger operation may be a selection operation. For example, in response to detecting that a user selects a content block on the document page, the display of a second switch identifier such as a virtual button (e.g., a button for Switching to Card form) is triggered.

Step S302: in response to a trigger operation on the second switch identifier, display a preset page on the page of the first document, the preset page comprising content information corresponding to the content block.

In some embodiments of the present disclosure, in response to a trigger operation such as a click on the virtual button (e.g., a button for Switching to Card form) being detected, a preset page is displayed on the document page. The preset page comprises content information corresponding to the content block, such as an icon, a title, and designated content information such as at least a part of the content information of some content lines. The icon and title here may be a document icon and a document title of the document being edited on the document page.

The technical solution of the embodiments above supports the conversion of a part of content on the document page into a designated display form, to enrich the method of document editing and processing, and facilitate the generation of more expressive document content during document editing and processing.

In some embodiments, the target content comprises a plurality of content blocks, and the switch identifier comprises a second switch identifier. In response to a trigger operation on the plurality of content blocks on the page of the first document, the second switch identifier is displayed; in response to a trigger operation on the second switch identifier, a preset page on the page of the first document is displayed, the preset page comprising content information corresponding to the plurality of content blocks.

For example, as shown in FIG. 4, the embodiments supports an operation of concurrently converting multiple content lines 403, such as “Patent Law XXXXYY” and “Implementation Regulations of The Patent Law ZZZWWW”, on the editing region 401 of the document page 400. In response to a plurality of content lines 403 being selected, the display of a second interface 404 is triggered. The second interface 404 comprises the second switch identifier 405, such as a virtual button “Switch to a Card form”, or another virtual button “Switch to Inline form” is also displayed. The user clicking on the second switch identifier 405 displayed on the second interface 404, such as the “Switch to a Card form” virtual button, in response to the click operation, the display of a plurality of different fourth interfaces 501 and 502 such as graphical user interfaces on the document page 400 is triggered, as shown in FIG. 5. Each of the fourth interfaces corresponds to a content line. Each of the fourth interfaces such as the interface 501 displays a corresponding content line in the page form. The page form comprises an icon 511, a title 512 and designated content information 513, which displays at least a portion of content information, such as text information “XX” of the corresponding content line.

The above technical solution of the embodiments supports converting a plurality of parts of content on the document page into a designated display form respectively, enriches the method of document editing and processing, and facilitates the generation of more expressive document content during document editing and processing.

In some embodiments, a preset control in response to a trigger operation on the second switch identifier is displayed; in response to a trigger operation on the preset control, a second document that comprises the content block on the page of the first document is generated. For example, in response to detecting a user's trigger operation on the second switch identifier, such as a click operation, a preset control such as a virtual button is displayed. In response to detecting a trigger operation on the virtual button, such as a click operation, a second document is generated based on a part of the content on the document page, that is, the content of the second document is part of the content of the first document.

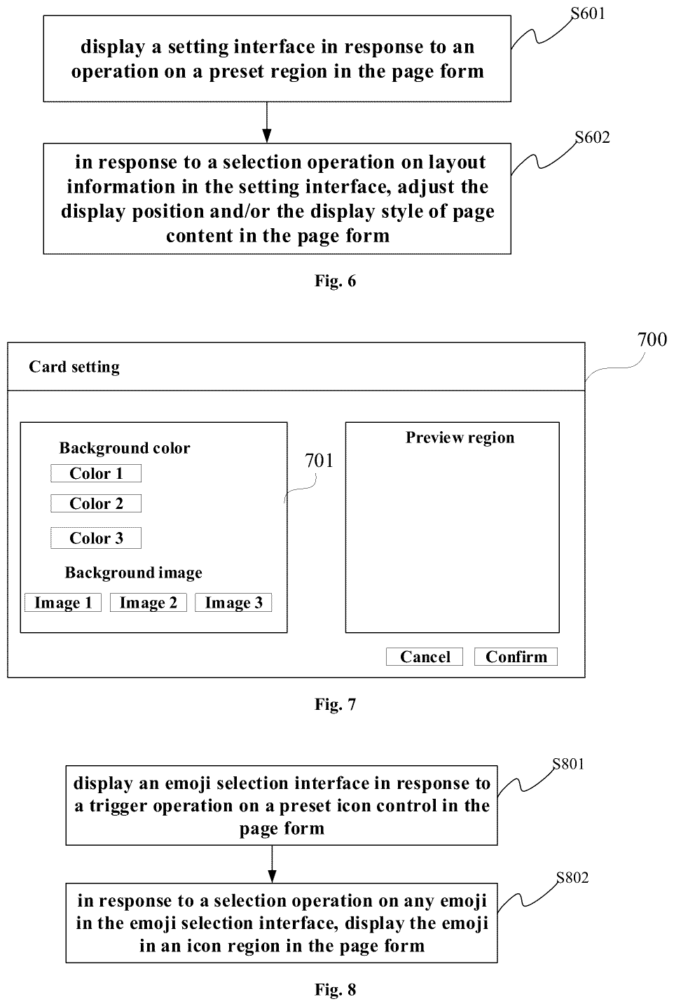

In some embodiments, as shown in FIG. 6, the method further comprises the following steps.

Step S601: display a setting interface in response to an operation on a preset region in the page form.

In some embodiments of the present disclosure, the preset region may be customized without limitation in the present disclosure. In response to the user's operation such as a click on the preset region in the page form being detected, the display of a setting interface is triggered.

Step S602: in response to a selection operation on layout information in the setting interface, adjust the display position and/or the display style of a page content in the page form.

In some embodiments of the present disclosure, the setting interface displays layout information, such as position information and style information for adjusting the display position and/or display style of a page content. In response to a user operation of selecting layout information in the setting interface being detected, the display position and/or display style of a page content in the page form is adjusted.

The technical solution of the embodiments modifies the display position and/or display style of the display content converted to the page form according to personalized needs of users, thereby further enriching the method of document editing and processing, being capable of meeting personalized needs of enabling more flexible and convenient editing users, and operations.

In some embodiments, the selection operation on layout information in the setting interface in step S602 comprises: moving the layout information along a preset direction such as left, right, up or down on a preset region of the setting interface; in response to moving the layout information to a preset position, determining the move operation as a selection operation on the layout information. With the method of moving, a selection operation on layout information may be performed conveniently and quickly, making editing operations more flexible and convenient.

In some embodiments, in response to the page form comprising a title and designated content information, a setting interface is displayed in response to an operation on a preset region in the page form; in response to an input operation on the setting interface, a background style of a region corresponding to the title and the designated content information in the page form is modified.

For example, in some embodiments, target background style data is obtained, in response to the input operation on the setting interface; the default background style data of the region corresponding to the title and the designated content information in the page form is modified to the target background style data; a rendering process is performed based on the target background style data to change the background style of the region corresponding to the title and the designated content information in the page form.

In some embodiments of the present application, the setting interface 700 may also display a control for target background style data, different target background style data corresponding to different background display styles. The input operation may be a click operation on the control above to trigger the obtaining of corresponding target background style data. Thereafter, the default background style data of the region corresponding to the title and the designated content information in the page form may be modified to the target background style data. After modifying the default background style data, a rendering process is performed based on the target background style data to change the background style of the region corresponding to the title and the designated content information in the page form.

In the technical solution of the embodiments, the background style of page content regions may be modified for the display content in the page form according to personalized needs of users, thereby further enriching the method of document editing and processing, being capable of meeting the personalized needs of users, and making editing operations more flexible and convenient.

In some embodiments, the page form comprising a background image. a setting interface is displayed, in response to an operation on a preset region in the page form; in response to a selection operation on a preset background image on the setting interface, the background image is displayed on a preset region in the page form.

As an example, as shown in FIG. 7, in response to an operation on a preset region in the page form, such as a click, being detected, the display of a setting interface 700 is triggered. The setting interface 700 displays one or more background images, such as “Image 1”, “Image 2”, and “Image 3”. In response to a selection operation such as a click on, for example, Image 3 being detected, an image 3 is displayed in a preset region such as a preview region. After previewing, the user clicks a “Confirm” control to complete the background image setting.

In some embodiments, in response to the background image being set to null and a background color being set to non-null, a background image region of the page is filled with the background color.

Referring to FIG. 7 again, a background image is set to None, i.e., no background image is set by the user, a background color may be filled in the background image region of the page. During the filling of a background color, any one of background colors on the setting interface 700 such as “Color 1”, “Color 2”, or “Color 3” may be selected to implement background color filling.

In the technical solution of the embodiments above, the background image and/or background color of the page content region may be set for the display content in the page form according to personalized needs of users, thereby further enriching the method of document editing and processing, being capable of meeting the personalized needs of users, and making editing operations more flexible and convenient.

In some embodiments, in response to the page form comprising an icon, as shown in FIG. 8, the method further comprises the following steps.

Step S801: display an emoji selection interface in response to a trigger operation on a preset icon control in the page form.

In some embodiments of the present disclosure, the preset icon control may be a control being configured to set emojis. In response to a trigger operation such as a click on the preset icon control being detected, the display of an emoji selection interface is triggered, in which a plurality of different emojis may be displayed.

Step S802: in response to a selection operation on any emoji in the emoji selection interface, display the emoji in an icon region in the page form.

In some embodiments of the present disclosure, the user may select any of different emojis displayed on the emoji selection interface as a target emoji, and display the target emoji on an icon region, which may be, but is not limited to, a top region in the page form.

In the embodiments above, emojis may be added to the content displayed in the page form to enrich the user's personalization settings, thereby enabling the display of more abundant information and further increasing the probability that users click on a link to read the content linked.

In some embodiments, the target content comprises a content block, and the switch identifier comprises a second switch identifier. In response to a trigger operation on the content block on the page of the first document, the second switch identifier is displayed; in response to a trigger operation on the second switch identifier, a preset page is displayed on the page of the first document, the preset page comprising content information corresponding to the content block; in response to a trigger operation on a preset icon control in the page form, and in response to determining that there is an emoji in the content block on the page of the first document, the emoji in the content block on the emoji selection interface is displayed as a recommended emoji.

In some embodiments, in response to a trigger operation on the preset icon control in the page form, and in response to determining that there is an emoji in the content block on the page of the first document, the emoji in the content block is displayed on the emoji selection interface as a recommended emoji. For example, in response to the content block displayed on the page of the first document, such as a content line, is switched to the page form, and in response to the presence of an input emoji in the content block, an operation such as a click on the preset icon control being detected, the emoji in the content block is displayed on the emoji selection interface as a recommended emoji to allow the user to prioritize the display of the emoji in the content block on an icon region in the page form.

In some embodiments, in response to a trigger operation on the second switch identifier, and in response to determining that there is an emoji in the content block on the page of the first document, the emoji is used as an emoji on the preset page displayed on the page of the first document.

In some embodiments, in response to a trigger operation on the second switch identifier, and in response to determining that there is an emoji in the content block on the page of the first document, the emoji is used as an emoji on the preset page displayed on the page of the first document.

For example, in response to switching a content block such as a content line displayed on the page of the first document to the page form, and in response to the presence of an input emoji in the content block, the emoji in the content block is used as an emoji of the target content displayed on the preset page in the page form.

In the above embodiments of the present disclosure, emojis may be added in response to the display of a content block on the page of the first document is switched to the page form to enrich the user's personalization settings, thereby enabling the display of more abundant information and further increasing the probability that users click on the target content such as a link to read the content linked.

It should be noted that although the various steps of the method of this disclosure are described in a specific order as shown in the accompanying drawings, this does not require or imply that these steps must be performed in this specific order or that all steps must be performed to achieve the desired result. In addition or alternatively, some steps may be omitted, or a plurality of steps may be combined into one step for execution, and/or one step may be divided into a plurality of steps for execution. Additionally, it is easy to understand that these steps may be executed synchronously or asynchronously, e.g. via a plurality of modules/processes/threads.

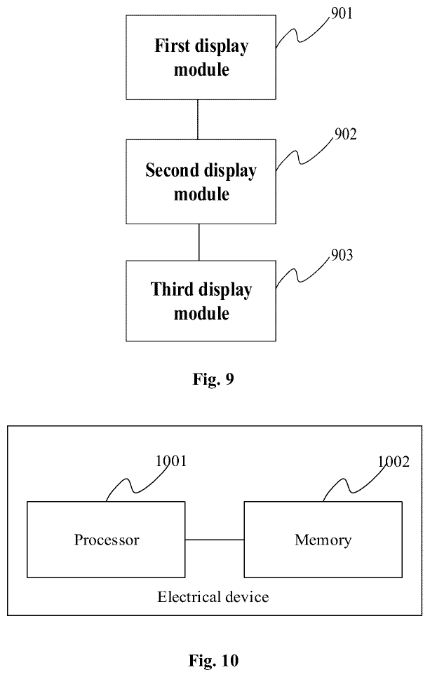

Some embodiments of the present disclosure provide an information processing apparatus. As shown in FIG. 9, the information processing apparatus comprises: a first display module 901 for displaying a page of a first document; a second display module 902 for displaying, in response to a trigger operation on a target content on the page of the first document, a switch identifier, wherein the target content is displayed in a first form; a third display module 903 for displaying, in response to a trigger operation on the switch identifier, the target content in a second form on the page of the first document, wherein the first form comprises one of a text form and a page form, and the second form comprises another of the text form and the page form.

In some embodiments, the page form comprises at least one of an icon, a background image, a title, or designated content information comprising content information corresponding to the target content.

In some embodiments, the target content comprises a target link, and the switch identifier comprises a first switch identifier, wherein the second display module 902 is used for in response to a trigger operation on the target link on the page of the first document, displaying the first switch identifier; the third display module 903 is used for displaying, in response to a trigger operation on the first switch identifier, a preset page on the page of the first document, the preset page comprising content information corresponding to the target link.

In some embodiments, the second display module 902 is used for: in response to receiving an input operation on the target link on the page of the first document, displaying the first switch identifier; the third display module 903 is used for displaying, in response to a trigger operation on the first switch identifier, a preset page on the page of the first document, the preset page comprising content information corresponding to the target link.

In some embodiments, the first switch identifier comprises a first identifier and at least one second identifier, wherein the first identifier is used to display and switch to a first form of the target link, and the second identifier is used to display and switch to a second form of the target link.

In some embodiments, the target content comprises a content block, and the switch identifier comprises a second switch identifier, wherein the second display module 902 is used for in response to a trigger operation on the content block on the page of the first document, displaying the second switch identifier; the third display module 902 is used for in response to a trigger operation on the second switch identifier, displaying a preset page on the page of the first document, the preset page comprising content information corresponding to the content block.

In some embodiments, the target content comprises a plurality of content blocks, and the switch identifier comprises a second switch identifier, wherein the second display module 902 is used for in response to a trigger operation on the plurality of content blocks on the page of the first document, displaying the second switch identifier; the third display module 902 is used for in response to a trigger operation on the second switch identifier, displaying a preset page on the page of the first document, the preset page comprising content information corresponding to the plurality of content blocks.

In some embodiments, the apparatus further comprises a document generation module for: displaying a preset control in response to a trigger operation on the second switch identifier; in response to a trigger operation on the preset control, generating a second document that comprises the content block on the page of the first document.

In some embodiments, the apparatus further comprises a setting module for: displaying a setting interface in response to an operation on a preset region in the page form; in response to a selection operation on layout information in the setting interface, adjusting the display position and/or the display style of the page content in the page form.

In some embodiments, the selection operation on layout information in the setting interface comprises: moving layout information along a preset direction in a preset region of the setting interface; in response to moving the layout information to a preset position, determining a selection operation on the layout information.

In some embodiments, the selection operation on layout information in the setting interface comprises: performing a move operation on layout information along a preset direction in a preset region of the setting interface; in response to moving the layout information to a preset position, determining the move operation as a selection operation on the layout information.

In some embodiments, in response to the page form comprising a title and designated content information, the setting module is further used for: displaying a setting interface in response to an operation on a preset region in the page form; in response to an input operation on the setting interface, modifying a background style for a region corresponding to the title and the designated content information in the page form.

In some embodiments, the setting module is used for: obtaining target background style data in response to the input operation on the setting interface; modifying the default background style data of the region corresponding to the title and the designated content information in the page form to the target background style data; performing a rendering process based on the target background style data to change the background style of the region corresponding to the title and the designated content information in the page form.

In some embodiments, in response to the page form comprising a background image, the setting module is further used for: displaying a setting interface in response to an operation on a preset region in the page form; in response to a selection operation on a preset background image in the setting interface, displaying the background image in a preset region in the page form.

In some embodiments, the setting module is further used for: in response to the background image being set to null and a background color being set to non-null, filling a background image region of the page with the background color.

In some embodiments, in response to the page form comprising an icon, the apparatus further comprises an emoji configuration module for: displaying an emoji selection interface in response to a trigger operation on a preset icon control in the page form; in response to a selection operation on any emoji in the emoji selection interface, displaying the emoji in an icon region in the page form.

In some embodiments, the target content comprises a content block, and the switch identifier comprises a second switch identifier, wherein the second display module 902 is used for: in response to a trigger operation on the content block on the page of the first document, displaying the second switch identifier; the third display module 903 is used for displaying, in response to a trigger operation on the second switch identifier, a preset page on the page of the first document, the preset page comprising content information corresponding to the content block. The emoji configuration module is further used for: in response to a trigger operation on a preset icon control in the page form, when it is determined that there is an emoji in the content block on the page of the first document, displaying the emoji in the content block in the emoji selection interface as a recommended emoji.

In some embodiments, in response to a trigger operation on the preset icon control in the page form, if it is determined that there is an emoji in the content block on the page of the first document, the emoji in the content block is displayed in the emoji selection interface as a recommended emoji.

In some embodiments, the emoji configuration module is further used for: in response to a trigger operation on the second switch identifier, when it is determined that there is an emoji in the content block on the page of the first document, using the emoji as an emoji on the preset page displayed on the page of the first document.

In some embodiments, the information processing method further comprises: in response to a trigger operation on the second switch identifier, if it is determined that there is an emoji in the content block on the page of the first document, using the emoji as an emoji on the preset page displayed on the page of the first document.

For the apparatus described in the above embodiment, the specific ways in which the various modules of the apparatus operate and the technical effect produced accordingly have been described in detail in the embodiments of the relevant method, and will not be explained in detail here.

It should be noted that although some modules or units of the device used for action execution are mentioned in the detailed description above, this division is not mandatory. In fact, according to embodiments of the present disclosure, the features and functions of two or more modules or units described above may be embodied in a single module or unit. On the contrary, the feature and function of a module or unit described above may be further divided into multiple modules or units. The component illustrated as a module or unit may or may not be a physical unit, may be located in one place, or may be distributed on multiple network units. Some or all of the modules may be selected according to actual needs to implement the solution of the present disclosure, as may be understood and implemented by those skilled in the art without the need for creative effort.

Some embodiments of the present disclosure further provides a computer readable storage medium having stored thereon a computer program that, when executed by a processor, implement the steps of the information processing method of any embodiment described above.

In some embodiments of the present disclosure, the readable storage medium may be, for example, but not limited to, an electronic, magnetic, optical, electromagnetic, infrared, or semiconductor system, apparatus, or device, or any combination of the above. More specific examples (non-exhaustive lists) of readable storage medium comprise: electrical connection with one or more wires, portable disk, hard disk, random access memory (RAM), read only memory (ROM), erasable programmable read only memory (EPROM or flash), fiber optics, portable compact disk Read only memory (CD-ROM), optical storage device, magnetic storage device, or any suitable combination of the foregoing.

The computer readable storage medium may comprise a data signal that is propagated in the baseband or as part of a carrier, carrying computer readable program code. Such propagated data signals can take a variety of forms comprising, but not limited to, electromagnetic signals, optical signals, or any suitable combination of the foregoing. The readable storage medium can also be any readable medium other than a readable storage medium, which can transmit, propagate, or transport a program for use by or in connection with the instruction execution system, apparatus, or device. Program code embodied on a readable storage medium may be transmitted by any suitable medium, comprising but not limited to wireless, wire, fiber optic cable, RF, etc., or any suitable combination of the foregoing.

Some embodiments of the present disclosure further provides an electronic device. As shown in FIG. 10, the electronic device may comprise a processor 1001 and a memory 1002 for storing a computer program. Wherein, the processor 1001 is configured to perform the steps of the information processing method of any embodiment described above by executing the computer program.

Through the description of the above embodiments, those skilled in the art will readily understand that the embodiment described herein may be implemented by software or a combination of software and necessary hardware. Therefore, the technical solution according to the present disclosure may be embodied in the form of a software product, which may be stored on a non-volatile storage medium (such as CD-ROM, USB flash drive, portable hard drive, etc.) or on a network, which comprises instructions to enable a computing device (such as a personal computer, server, or network device) to perform the information processing method according to the present disclosure.

Note that, in this description, the use of relational terms, if any, such as “first” and “second” and the like are used solely to distinguish one from another entity or action without necessarily requiring or implying any actual such relationship or order between such entities or actions. Further, terms “comprise”, “comprise” or their any other variations are intended to encompass non-exclusive composition, so that a process, method, product or device comprising a series of factors may comprise not only these factors, but also other factors that are not listed explicitly, or factors intrinsic to this process, method, product or device. Without limitation, a factor defined by wording “comprise one . . . ” does not exclude the existence of other same factors in a process, method, product or device comprising such factor.

The above descriptions are only specific embodiments of the present disclosure, so that those skilled in the art can understand or implement the present disclosure. Various modifications to these embodiments will be apparent to those skilled in the art, and the generic principles defined herein may be implemented in other embodiments without departing from the spirit or scope of the present disclosure. Accordingly, the present disclosure should not be limited to the specific embodiments described herein, but should be accorded the broadest scope consistent with the principles and novel features disclosed herein.

1. An information processing method, comprising:
displaying a page of a first document;
displaying a switch identifier, in response to a trigger operation on a target content on the page of the first document, wherein the target content is displayed in a first form; and
displaying the target content in a second form on the page of the first document, in response to a trigger operation on the switch identifier, wherein the first form comprises one of a text form and a page form, and the second form comprises another-of the text form and the page form.

2. The information processing method according to claim 1, wherein the page form comprises at least one of an icon, a background image, a title, or designated content information comprising content information corresponding to the target content.

3. The information processing method according to claim 1, wherein the target content comprises a target link, the switch identifier comprises a first switch identifier,
the displaying the switch identifier comprises:
displaying the first switch identifier, in response to the trigger operation on the target link on the page of the first document; and
the displaying the target content in the second form on the page of the first document comprises:
displaying a preset page on the page of the first document, in response to the trigger operation on the first switch identifier, the preset page comprising content information corresponding to the target link.

4. The information processing method according to claim 1, further comprising:
displaying a first switch identifier, in response to receiving an input operation on a target link on the page of the first document; and
displaying a preset page on the page of the first document, in response to a trigger operation on the first switch identifier, the preset page comprising content information corresponding to the target link.

5. The information processing method according to claim 3, wherein the first switch identifier comprises a first identifier and at least one second identifier, the first identifier being configured to display and switch to the first form of the target link, and the second identifier being configured to display and switch to the second form of the target link.

6. The information processing method according to claim 1, wherein the target content comprises a content block, and the switch identifier comprises a second switch identifier;
the displaying the switch identifier comprises:
displaying the second switch identifier, in response to the trigger operation on the content block on the page of the first document; and
the displaying the target content in the second form on the page of the first document comprises:
displaying a preset page on the page of the first document, in response to the trigger operation on the second switch identifier, the preset page comprising content information corresponding to the content block,.

7. The information processing method according to claim 1, wherein the target content comprises a plurality of content blocks, and the switch identifier comprises a second switch identifier;
the displaying the switch identifier comprises:
displaying the second switch identifier, in response to the trigger operation on the plurality of content blocks on the page of the first document; and
the displaying the target content in a second form on the page of the first document comprises:
displaying a preset page on the page of the first document, in response to the trigger operation on the second switch identifier, the preset page comprising content information corresponding to the plurality of content blocks.

8. The information processing method according to claim 6, wherein the displaying the target content in the second form on the page of the first document comprises:
displaying a preset control, in response to a trigger operation on the second switch identifier; and
generating a second document, in response to a trigger operation on the preset control, the second document comprising the content block on the page of the first document.

9. The information processing method according to claim 1, further comprising:
displaying a setting interface, in response to an operation on a preset region in the page form; and
adjusting at least one of a display position or a display style of a page content in the page form, in response to a selection operation on layout information in the setting interface.

10. The information processing method according to claim 9, wherein the selection operation on the layout information in the setting interface is determined by following steps:
performing a move operation on the layout information along a preset direction in a preset region of the setting interface; and
determining the move operation as the selection operation on the layout information, in response to moving the layout information to a preset position.

11. The information processing method according to claim 2, further comprising:
displaying a setting interface, in response to the page form comprising the title and the designated content information, and in response to an operation on a preset region in the page form; and
modifying a background style for a region corresponding to the title and the designated content information in the page form, in response to an input operation on the setting interface.

12. The information processing method according to claim 11, wherein the modifying the background style for the region corresponding to the title and the designated content information in the page form, in response to the input operation on the setting interface comprises:
obtaining target background style data, in response to the input operation on the setting interface;
modifying default background style data of the region corresponding to the title and the designated content information in the page form to the target background style data; and
performing a rendering process based on the target background style data to change the background style of the region corresponding to the title and the designated content information in the page form.

13. The information processing method according to claim 2, further comprising:
displaying a setting interface, in response to the page form comprising the background image, and in response to an operation on a preset region in the page form; and
displaying the background image in the preset region in the page form, in response to a selection operation on a preset background image in the setting interface.

14. The information processing method according to claim 13, further comprising:
filling a background image region of the page with a background color, in response to the background image being set to null and a background color being set to non-null.

15. The information processing method according to claim 2, further comprising:
displaying an emoji selection interface, in response to the page form comprising the icon, and in response to a trigger operation on a preset icon control in the page form; and
displaying an emoji in an icon region in the page form, in response to a selection operation on the emoji in the emoji selection interface.

16. The information processing method according to claim 15, wherein the target content comprises a content block, the switch identifier comprises a second switch identifier,
the displaying the switch identifier comprises:
displaying the second switch identifier, in response to the trigger operation on the content block on the page of the first document; and
the displaying the target content in the second form on the page of the first document comprises:
displaying a preset page on the page of the first document, in response to the trigger operation on the second switch identifier, the preset page comprising the content information corresponding to the content block;
the information processing method further comprising:
displaying an emoji in the content block in the emoji selection interface as a recommended emoji, in response to a trigger operation on a preset icon control in the page form, and in response to determining that there is the emoji in the content block on the page of the first document.

17. The information processing method according to claim 6, further comprising:
determining an emoji in the content block as an emoji on the preset page displayed on the page of the first document, in response to a trigger operation on the second switch identifier, and in response to determining that there is the emoji in the content block on the page of the first document.

18. (canceled)

19. A non-transitory computer-readable storage medium stored thereon a computer program that, when executed by a processor, implements steps of an information processing method, comprising:
displaying a page of a first document;
displaying a switch identifier, in response to a trigger operation on a target content on the page of the first document, wherein the target content is displayed in a first form; and
displaying the target content in a second form on the page of the first document, in response to a trigger operation on the switch identifier, wherein the first form comprises one of a text form and a page form, and the second form comprises another of the text form and the page form.

20. An electronic device, comprising:
a processor; and
a memory for storing a computer program;
wherein, the processor is configured to perform steps of an information processing method. comprising:
displaying a page of a first document;
displaying a switch identifier, in response to a trigger operation on a target content on the page of the first document, wherein the target content is displayed in a first form; and
displaying the target content in a second form on the page of the first document, in response to a trigger operation on the switch identifier, wherein the first form comprises one of a text form and a page form, and the second form comprises another of the text form and the page form.

21. (canceled)
